(19) United States
(12) Patent Application Publication
(10) Pub. No.: US 2017/0191534 A1
(43) Pub. Date: Jul. 6, 2017

(54) BICYCLE DISC BRAKE CALIPER

(71) Applicant: SHIMANO INC., Sakai City (JP)

(72) Inventor: Tatsuya KAWAKAMI, Sakai City (JP)

(73) Assignee: SHIMANO INC., Sakai City (JP)

(21) Appl. No.: 14/989,723

(22) Filed: Jan. 6, 2016

(51) Int. Cl. F16D 65/00; F16D 55/225

(52) U.S. Cl. CPC F16D 65/0068; F16D 55/225; F16D 2055/0016

(57) ABSTRACT

A bicycle disc brake caliper comprises a first brake pad, a second brake pad, an actuation structure, and a link structure. The second brake pad is arranged to face the first brake pad. The actuation structure moves the first brake pad toward the second brake pad. The link structure is coupled to the first brake pad to transmit a movement of the first brake pad to the second brake pad to move the second brake pad toward the first brake pad.

### BACKGROUND OF THE INVENTION

Field of the Invention

The present invention relates to a bicycle disc brake caliper.

Discussion of the Background

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. One bicycle component that has been extensively redesigned is a bicycle brake.

### SUMMARY OF THE INVENTION

In accordance with a first aspect of the present invention, a bicycle disc brake caliper comprises a first brake pad, a second brake pad, an actuation structure, and a link structure. The second brake pad is arranged to face the first brake pad. The actuation structure moves the first brake pad toward the second brake pad. The link structure is coupled to the first brake pad to transmit a movement of the first brake pad to the second brake pad to move the second brake pad toward the first brake pad.

With the bicycle disc brake caliper according to the first aspect, it is possible to utilize the movement of the first brake pad to move the second brake pad using the link structure, allowing the structure of the bicycle disc brake caliper to be simplified.

In accordance with a second aspect of the present invention, the bicycle disc brake caliper according to the first aspect further comprises a caliper base coupled to a bicycle body. The link structure is provided on the caliper base.

With the bicycle disc brake caliper according to the second aspect, it is possible to support the link structure via the caliper base relative to the bicycle body, allowing operation of the link structure to be stabilized.

In accordance with a third aspect of the present invention, the bicycle disc brake caliper according to the second aspect is configured so that the link structure includes a piston link to move the second brake pad toward the first brake pad, and a first support link pivotally coupled to the caliper base about a first base axis and pivotally coupled to the piston link about a first support axis.

With the bicycle disc brake caliper according to the third aspect, it is possible to move the second brake pad toward the first brake pad using the piston link and the first support link.

In accordance with a fourth aspect of the present invention, the bicycle disc brake caliper according to the third aspect is configured so that the first support link is coupled to the first brake pad to transmit the movement of the first brake pad to the piston link.

With the bicycle disc brake caliper according to the fourth aspect, it is possible to transmit the movement of the first brake pad to the second brake pad via the first support link and the piston link.

In accordance with a fifth aspect of the present invention, the bicycle disc brake caliper according to the fourth aspect is configured so that the first support link includes a pad coupling portion coupled to the first brake pad. The pad coupling portion is arranged farther from the first support axis than the first base axis.

With the bicycle disc brake caliper according to the fifth aspect, it is possible to move the piston link via the first support link in an opposite direction opposite to a direction in which the first brake pad moves. This allows the second brake pad to move in the opposite direction in conjunction with the movement of the first brake pad.

In accordance with a sixth aspect of the present invention, the bicycle disc brake caliper according to the fifth aspect is configured so that the first brake pad includes a first back plate and a first friction member attached to the first back plate. The pad coupling portion of the first support link is pivotally coupled to the first back plate about a coupling axis.

With the bicycle disc brake caliper according to the sixth aspect, it is possible to couple the first support link to the first back plate of the first brake pad via the pad coupling portion. This can improve transmission efficiency of the movement of the first brake pad relative to the second brake pad.

In accordance with a seventh aspect of the present invention, the bicycle disc brake caliper according to any one of the third to sixth aspects is configured so that the actuation structure is provided on the piston link.

With the bicycle disc brake caliper according to the seventh aspect, a reaction force is applied from the actuation structure to the piston link when an actuation force is applied from the actuation structure to the first brake pad. Thus, it is possible to utilize the reaction force as an actuation force for the second brake pad.

In accordance with an eighth aspect of the present invention, the bicycle disc brake caliper according to any one of the third to seventh aspects is configured so that at least one of the first brake pad and the second brake pad is mounted to the piston link.

With the bicycle disc brake caliper according to the eighth aspect, it is possible to simplify the structure of the bicycle disc brake caliper.

In accordance with a ninth aspect of the present invention, the bicycle disc brake caliper according to the eighth aspect is configured so that the piston link has a guide rod. At least one of the first brake pad and the second brake pad is movably mounted to the piston link along the guide rod.

With the bicycle disc brake caliper according to the ninth aspect, it is possible to guide the at least one of the first brake pad and the second brake pad relative to the piston link, allowing a movement of the at least one of the first brake pad and the second brake pad to be stabilized.

In accordance with a tenth aspect of the present invention, the bicycle disc brake caliper according to any one of the third to ninth aspects is configured so that the piston link has a cylindrical part defining an internal space. The first brake pad and the second brake pad are at least partially arranged in the internal space of the cylindrical part.

With the bicycle disc brake caliper according to the tenth aspect, it is possible to protect at least part of the first brake pad and the second brake pad using the piston link.

In accordance with an eleventh aspect of the present invention, the bicycle disc brake caliper according to the tenth aspect is configured so that the cylindrical part includes a plurality of side walls defining a rectangular cylindrical shape. The actuation structure is attached to one of the plurality of side walls.

With the bicycle disc brake caliper according to the eleventh aspect, it is possible to increase strength of the piston link because of the rectangular cylindrical shape, allowing the actuation structure to be stably supported via the piston link.

In accordance with a twelfth aspect of the present invention, the bicycle disc brake caliper according to any one of the third to eleventh aspects is configured so that the link structure further includes a second support link pivotally coupled to the caliper base about a second base axis and pivotally coupled to the piston link about a second support axis.

With the bicycle disc brake caliper according to the twelfth aspect, it is possible to stably support the piston link relative to the caliper base along with the first support link.

In accordance with a thirteenth aspect of the present invention, the bicycle disc brake caliper according to the twelfth aspect is configured so that the first and second support axes and the first and second base axes are arranged so as to constitute a four-bar linkage between the piston link and the caliper base.

With the bicycle disc brake caliper according to the thirteenth aspect, it is possible to stabilize a movement of the piston link relative to the caliper base using the four-bar linkage.

In accordance with a fourteenth aspect of the present invention, the bicycle disc brake caliper according to the thirteenth aspect is configured so that the first and second support axes and the first and second base axes are arranged so as to be parallel to each other.

With the bicycle disc brake caliper according to the fourteenth aspect, it is possible to make the movement of the piston link relative to the caliper base more stable using the four-bar linkage.

In accordance with a fifteenth aspect of the present invention, the bicycle disc brake caliper according to the thirteenth or fourteenth aspects is configured so that a first distance defined between the first support axis and the first base axis is equal to a second distance defined between the second support axis and the second base axis. The third distance defined between the first support axis and the second support axis is equal to a fourth distance defined between the first base axis and the second base axis. The first distance and the second distance are shorter than the third distance and the fourth distance.

With the bicycle disc brake caliper according to the fifteenth aspect, it is possible to make the movement of the piston link relative to the caliper base more stable using the four-bar linkage.

In accordance with a sixteenth aspect of the present invention, the bicycle disc brake caliper according to any one of the third to fifteenth aspects is configured so that the actuation structure includes a rotational member coupled to the piston link to rotate relative to the piston link in response to an operation force applied via a control cable.

With the bicycle disc brake caliper according to the sixteenth aspect, it is possible to receive the operation force from the control cable via the rotational member.

In accordance with a seventeenth aspect of the present invention, the bicycle disc brake caliper according to the sixteenth aspect is configured so that the actuation structure includes a cam mechanism provided between the rotational member and the piston link to move the rotational member along a rotational axis of the rotational member relative to the piston link.

With the bicycle disc brake caliper according to the seventeenth aspect, it is possible to convert the operation force to an axial movement of the rotational member via the cam mechanism.

In accordance with an eighteenth aspect of the present invention, the bicycle disc brake caliper according to the seventeenth aspect is configured so that the cam mechanism includes a first cam member, a second cam member, and an intermediate member. The first cam member is provided on the rotational member. The second cam member is provided on the piston link and facing the first cam member. The intermediate member is arranged between the first cam member and the second cam member.

With the bicycle disc brake caliper according to the eighteenth aspect, it is possible to convert rotation of the rotational member into the axial movement of the rotational member via the first cam member, the second cam member, and the intermediate member.

In accordance with a nineteenth aspect of the present invention, the bicycle disc brake caliper according to the eighteenth aspect further comprises an adjustment structure changing axial positions of the first cam member and the second cam member relative to the piston link along the rotational axis to adjust a rest position of the first brake pad relative to the caliper base.

With the bicycle disc brake caliper according to the nineteenth aspect, it is possible to adjust a position of the first brake pad relative to the piston link via the adjustment member.

In accordance with a twentieth aspect of the present invention, the bicycle disc brake caliper according to any one of the third to nineteenth aspects further comprises an adjustment structure changing a position of the actuation structure relative to the piston link to adjust a rest position of the first brake pad relative to the caliper base.

With the bicycle disc brake caliper according to the twentieth aspect, it is possible to adjust a position of the first brake pad relative to the piston link via the adjustment member.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a bicycle disc brake caliper in accordance with an embodiment of the present invention.

FIG. 2 is a perspective view of the bicycle disc brake caliper illustrated in FIG. 1.

FIG. 3 is a bottom view of the bicycle disc brake caliper illustrated in FIG. 1.

FIG. 4 is a side elevational view of the bicycle disc brake caliper illustrated in FIG. 1.

FIG. 5 is a side elevational view of the bicycle disc brake caliper illustrated in FIG. 1.

FIG. 6 is a perspective view of the bicycle disc brake caliper illustrated in FIG. 1 with a caliper base omitted.

FIG. 7 is an exploded perspective view of a link structure of the bicycle disc brake caliper illustrated in FIG. 1.

FIG. 8 is an exploded perspective view of the bicycle disc brake caliper illustrated in FIG. 1.

FIG. 9 is an exploded perspective view of the bicycle disc brake caliper illustrated in FIG. 1.

FIG. 10 is a cross-sectional view of the bicycle disc brake caliper taken along line X-X of FIG. 3.

FIG. 11 is a cross-sectional view of the bicycle disc brake caliper taken along line XI-XI of FIG. 10.

FIG. 12 is a perspective view of a first brake pad and a first support link of the bicycle disc brake caliper illustrated in FIG. 1.

FIG. 13 is a perspective view of the bicycle disc brake caliper illustrated in FIG. 1 with the caliper base omitted.

FIG. 14 is a perspective view of the bicycle disc brake caliper illustrated in FIG. 1 with the caliper base omitted.

FIG. 15 is an exploded perspective view of an actuation structure of the bicycle disc brake caliper illustrated in FIG. 1.

FIG. 16 is an exploded perspective view of the actuation structure of the bicycle disc brake caliper illustrated in FIG. 1.

FIG. 17 is a partial cross-sectional view of the actuation structure of the bicycle disc brake caliper illustrated in FIG. 1 (rest position).

FIG. 18 is a partial cross-sectional view of the actuation structure of the bicycle disc brake caliper illustrated in FIG. 1 (operated position).

FIG. 19 is a cross-sectional view of the bicycle disc brake caliper taken along line IXX-IXX of FIG. 10.

### DESCRIPTION OF THE EMBODIMENTS

The embodiment(s) will now be described with reference to the accompanying drawings, wherein like reference numerals designate corresponding or identical elements throughout the various drawings.

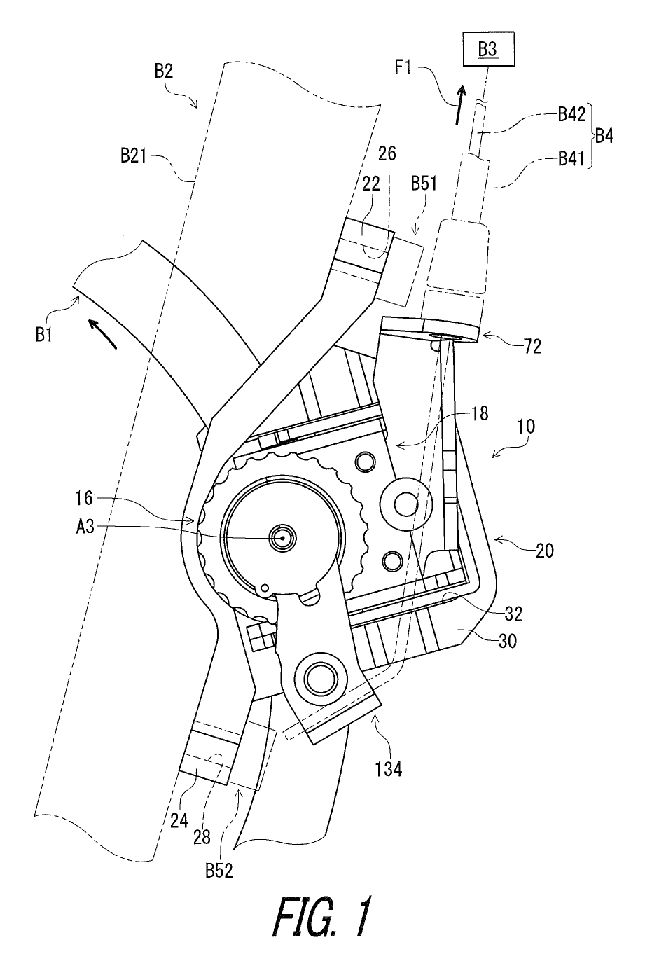

Referring initially to FIG. 1, a bicycle disc brake caliper 10 in accordance with an embodiment applies a braking force to a disc brake rotor B1. The bicycle disc brake caliper 10 is mounted to a bicycle body B2. Examples of the bicycle body B2 include a bicycle frame and a front fork rotatably mounted to the bicycle frame. In this embodiment, the bicycle disc brake caliper 10 is used as a front disc brake caliper mounted to a front fork B21 of the bicycle body B2. However, the bicycle disc brake caliper 10 can be used as a rear disc brake caliper mounted to a chain stay of the bicycle frame, for example.

The bicycle disc brake caliper 10 is operatively coupled to a brake operating device B3 via a control cable B4 such as a Bowden cable. The bicycle disc brake caliper 10 applies the braking force to the disc brake rotor B1 in response to an operation force F1 applied from the brake operating device B3 via the control cable B4. The control cable B4 includes an outer casing B41 and an inner wire B42. The inner wire B42 is movably provided in the outer casing B41. In this embodiment, the operation force F1 is a pulling force transmitted from the brake operating device B3 via the inner wire B42 of the control cable B4.

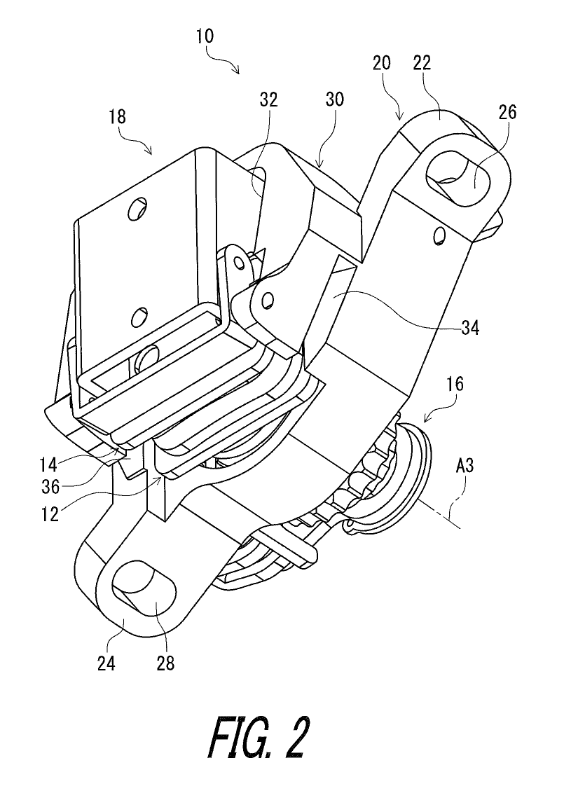

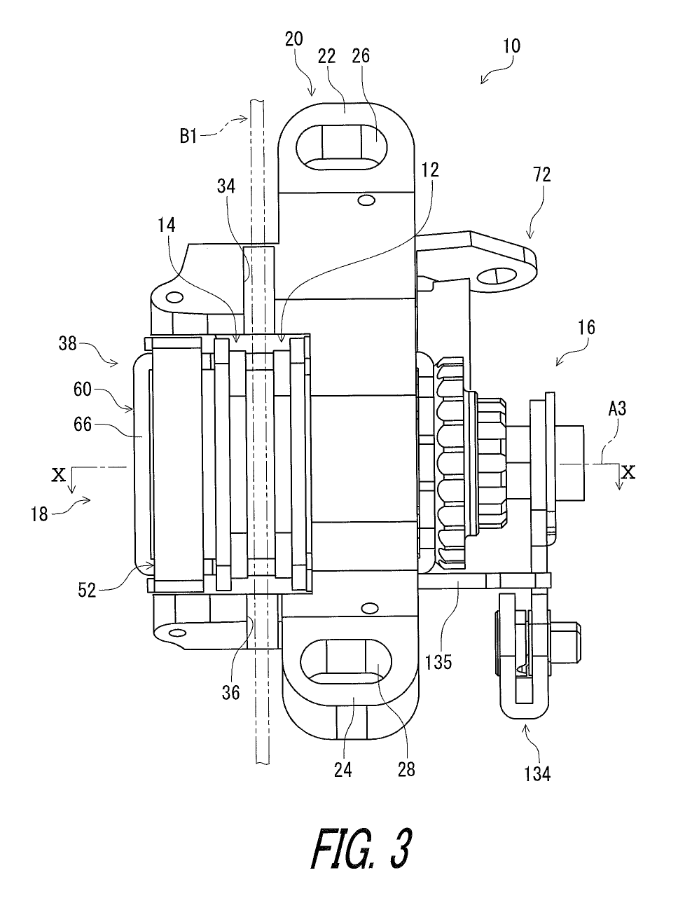

As seen in FIGS. 2 and 3, the bicycle disc brake caliper 10 comprises a first brake pad 12, a second brake pad 14, an actuation structure 16, and a link structure 18. The second brake pad 14 is arranged to face the first brake pad 12. The actuation structure 16 moves the first brake pad 12 toward the second brake pad 14. The link structure 18 is coupled to the first brake pad 12 to transmit a movement of the first brake pad 12 to the second brake pad 14 to move the second brake pad 14 toward the first brake pad 12.

The bicycle disc brake caliper 10 further comprises a caliper base 20 coupled to the bicycle body B2 (FIG. 1). The link structure 18 is provided on the caliper base 20. However, the caliper base 20 can be omitted from the bicycle disc brake caliper 10. In such an embodiment, the actuation structure 16 and the link structure 18 are directly mounted to the bicycle body B2 (FIG. 1).

As seen in FIG. 2, the caliper base 20 includes a first mounting part 22 and a second mounting part 24. In this embodiment, the first mounting part 22 includes a first mounting hole 26. The second mounting part 24 includes a second mounting hole 28.

As seen in FIG. 1, the caliper base 20 is mounted to the bicycle body B2 via the first mounting part 22 and the second mounting part 24 with mounting bolts B51 and B52. The mounting bolts B51 and B52 respectively extend through the first mounting hole 26 and the second mounting hole 28 to secure the caliper base 20 to the bicycle body B2.

As seen in FIGS. 1 and 2, the caliper base 20 includes a base frame 30 having a substantially annular shape. The base frame 30 includes an accommodation opening 32. The link structure 18 is provided in the accommodation opening 32. The first mounting part 22 and the second mounting part 24 extend from the base frame 30.

As seen in FIG. 3, the base frame 30 includes a first slit 34 and a second slit 36. The disc brake rotor B1 is provided in the first slit 34 and the second slit 36 in a mounting state where the bicycle disc brake caliper 10 is mounted to the bicycle body B2 (FIG. 1).

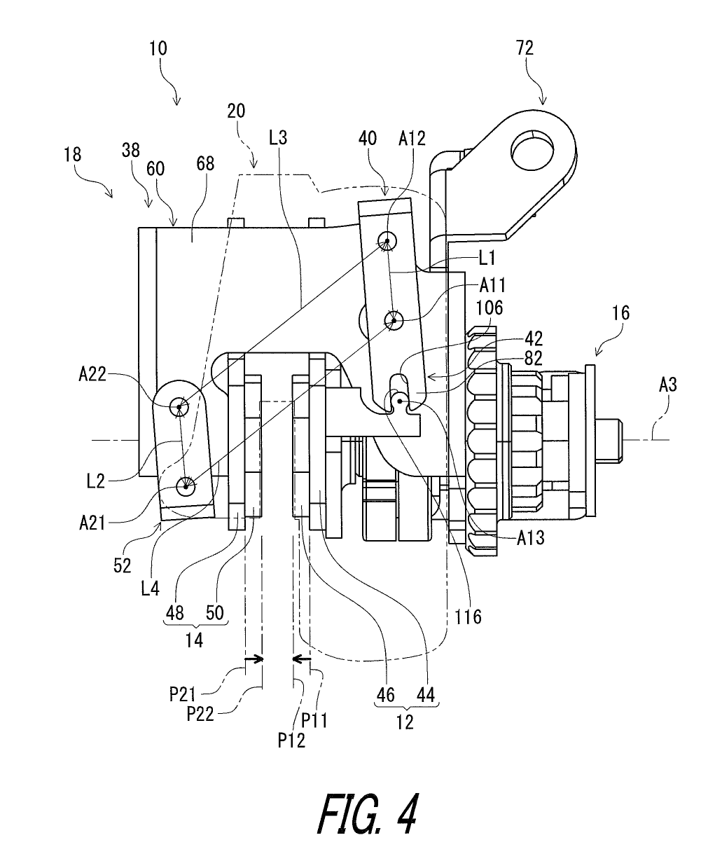

As seen in FIG. 4, the first brake pad 12 is movable relative to the caliper base 20 between a first rest position P11 and a first operated position P12. The second brake pad 14 is movable relative to the caliper base 20 between a second rest position P21 and a second operated position P22. The first rest position P11 can be also referred to as a rest position P11.

In the present application, the term “rest position” as used herein refers to a position at which a movable part such as the first brake pad 12 and the second brake pad 14 remains stationary in a state where the movable member is not operated by the user. The term “operated position” as used herein refers to a position at which the movable member has been operated by the user to perform the operation of the bicycle disc brake caliper 10.

As seen in FIG. 4, the actuation structure 16 moves the first brake pad 12 from the first rest position P11 toward the first operated position P12. The link structure 18 moves the second brake pad 14 from the second rest position P21 toward the second operated position P22 in response to the movement of the first brake pad 12 from the first rest position P11 toward the first operated position P12.

The link structure 18 includes a piston link 38 to move the second brake pad 14 toward the first brake pad 12. In the illustrated embodiment, the piston link 38 is in contact with the second brake pad 14 to transmit the movement of the first brake pad 12 to the second brake pad 14.

The link structure 18 includes a first support link 40 pivotally coupled to the caliper base 20 about a first base axis A11. The first support link 40 is pivotally coupled to the piston link 38 about a first support axis A12.

The first support link 40 is coupled to the first brake pad 12 to transmit the movement of the first brake pad 12 to the piston link 38. In this embodiment, the first support link 40 includes a pad coupling portion 42 coupled to the first brake pad 12. The pad coupling portion 42 is arranged farther from the first support axis A12 than the first base axis A11.

The first brake pad 12 includes a first back plate 44 and a first friction member 46 attached to the first back plate 44. The pad coupling portion 42 of the first support link 40 is pivotally coupled to the first back plate 44 about a coupling axis A13. The first friction member 46 is slidable with the disc brake rotor B1. The second brake pad 14 includes a second back plate 48 and a second friction member 50 attached to the second back plate 48. The second friction member 50 is slidable with the disc brake rotor B1. In this embodiment, the first rest position P11 and the first operated position P12 are defined based on the first back plate 46. The second rest position P21 and the second operated position P22 are defined based on the second back plate 48.

The link structure 18 further includes a second support link 52 pivotally coupled to the caliper base 20 about a second base axis A21. The second support link 52 is pivotally coupled to the piston link 38 about a second support axis A22. The first brake pad 12 and the second brake pad 14 are provided between the first support link 40 and the second support link 52.

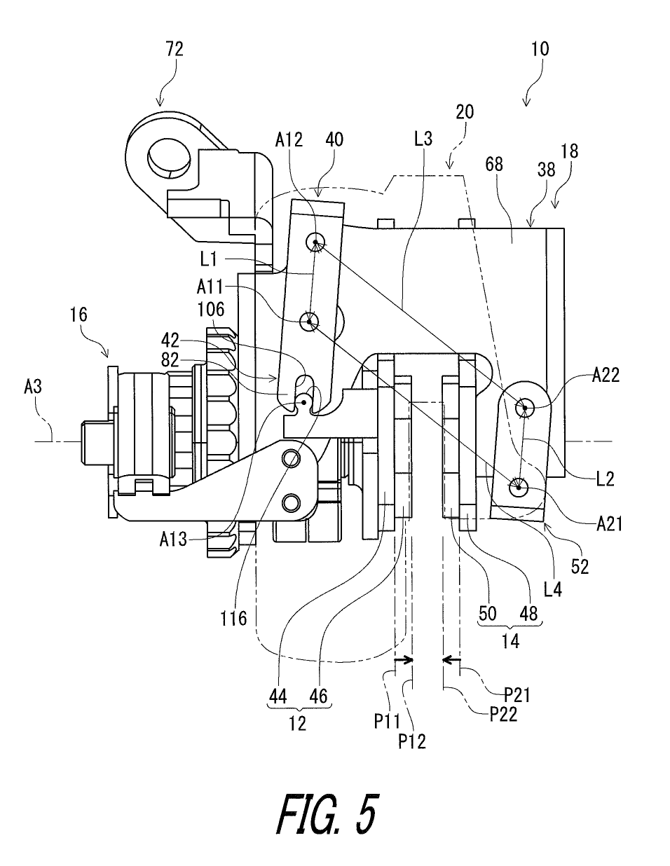

In this embodiment, as seen in FIGS. 4 and 5, the first and second support axes A12 and A22 and the first and second base axes A11 and A21 are arranged so as to constitute a four-bar linkage between the piston link 38 and the caliper base 20. Specifically, a first distance L1 defined between the first support axis A12 and the first base axis A11 is equal to a second distance L2 defined between the second support axis A22 and the second base axis A21. A third distance L3 defined between the first support axis A12 and the second support axis A22 is equal to a fourth distance L4 defined between the first base axis A11 and the second base axis A21. The first distance L1 and the second distance L2 are shorter than the third distance L3 and the fourth distance L4. However, the first distance L1 can be substantially equal to the second distance L2. The third distance L3 can be substantially equal to the fourth distance L4. Furthermore, the first distance L1 can be different from the second distance L2. The third distance L3 can be different from the fourth distance L4.

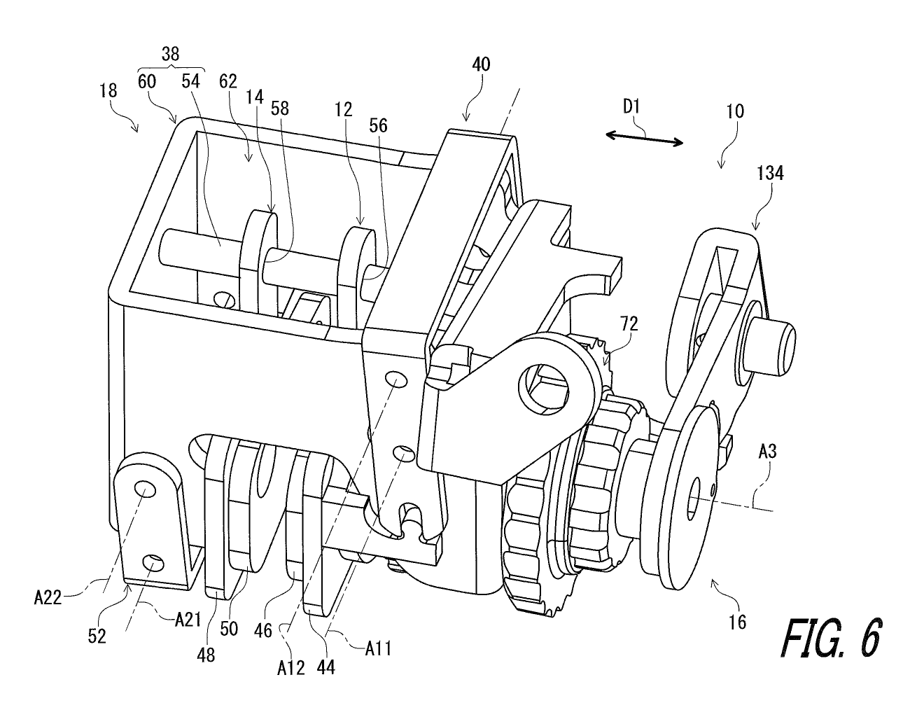

As seen in FIG. 6, the first and second support axes A12 and A22 and the first and second base axes A11 and A21 are arranged so as to be parallel to each other. However, at least one of the first and second support axes A12 and A22 and the first and second base axes A11 and A21 can be arranged so as to be non-parallel to another of the first and second support axes A12 and A22 and the first and second base axes A11 and A21.

At least one of the first brake pad 12 and the second brake pad 14 is mounted to the piston link 38. In this embodiment, the first brake pad 12 and the second brake pad 14 are mounted to the piston link 38. However, one of the first brake pad 12 and the second brake pad 14 can be mounted to another part such as the caliper base 20 or the bicycle body B2.

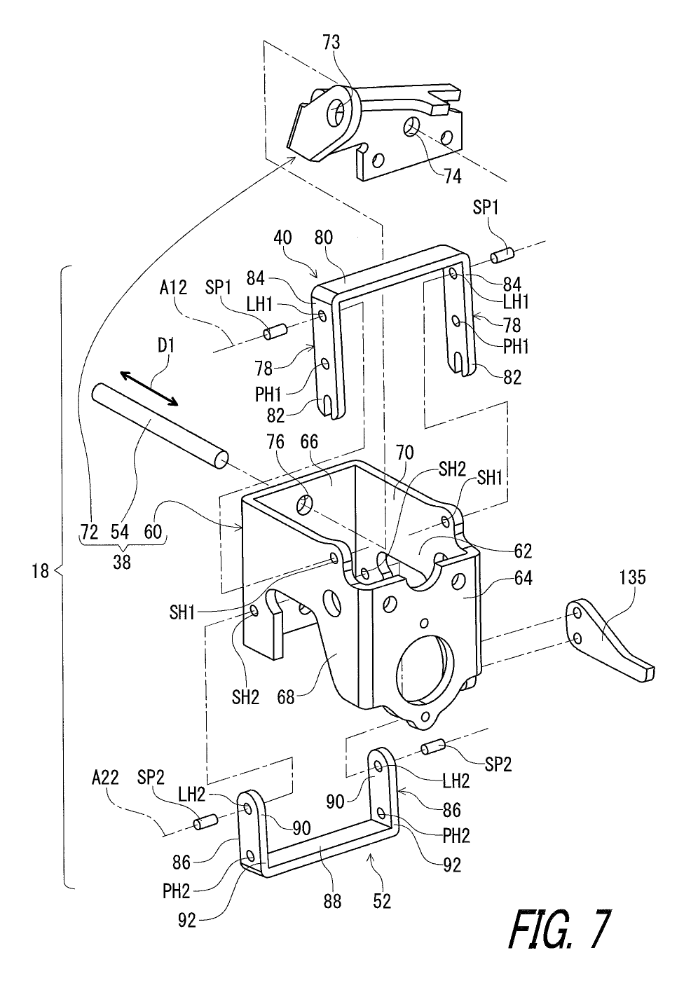

As seen in FIG. 7, the piston link 38 has a guide rod 54. At least one of the first brake pad 12 and the second brake pad 14 is movably mounted to the piston link 38 along the guide rod 54. In the illustrated embodiment, the first brake pad 12 and the second brake pad 14 are movably mounted to the piston link 38 along the guide rod 54. However, one of the first brake pad 12 and the second brake pad 14 can be movably mounted to another part such as the caliper base 20 or the bicycle body B2.

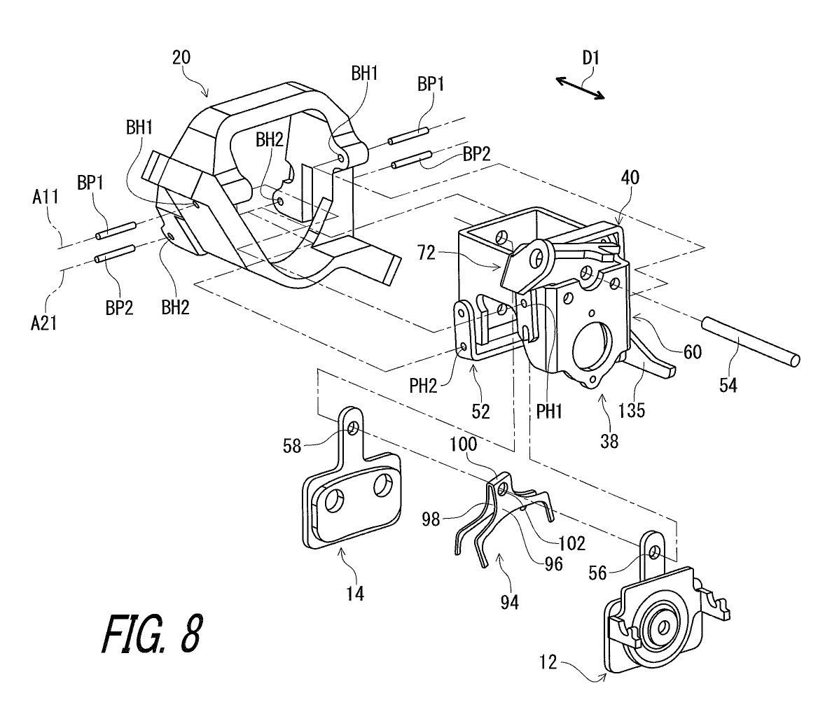

The guide rod 54 extends in an axial direction D1. The first brake pad 12 and the second brake pad 14 are movably mounted to the piston link 38 in the axial direction D1. As seen in FIG. 8, the first brake pad 12 includes a first guide hole 56. The second brake pad 14 includes a second guide hole 58. The guide rod 54 extends through the first guide hole 56 and the second guide hole 58. In this embodiment, the first back plate 44 includes the first guide hole 56, and the second back plate 48 includes the second guide hole 58.

As seen in FIG. 6, the piston link 38 has a cylindrical part 60 defining an internal space 62. The first brake pad 12 and the second brake pad 14 are at least partially arranged in the internal space 62 of the cylindrical part 60. In this embodiment, the first brake pad 12 and the second brake pad 14 are partially arranged in the internal space 62 of the cylindrical part 60. However, the first brake pad 12 and the second brake pad 14 can be entirely arranged in the internal space 62 of the cylindrical part 60. The guide rod 54 is attached to the cylindrical part 60.

As seen in FIG. 7, the cylindrical part 60 includes a plurality of side walls defining a rectangular cylindrical shape. In this embodiment, the side walls includes a first side wall 64, a second side wall 66, a third side wall 68, and a fourth side wall 70. The first side wall 64 is spaced apart from the second side wall 66 in the axial direction D1. The third side wall 68 extends between the first side wall 64 and the second side wall 66 in the axial direction D1. The fourth side wall 70 extends between the first side wall 64 and the second side wall 66 in the axial direction D1. The third side wall 68 is spaced apart from the fourth side wall 70. The internal space 62 is defined by the first side wall 64, the second side wall 66, the third side wall 68, and the fourth side wall 70.

The guide rod 54 is attached to the first side wall 64 and the second side wall 66 to extend between the first side wall 64 and the second side wall 66. Specifically, the piston link 38 includes a cable support 72 attached to the cylindrical part 60 to support the control cable B4. The cable support 72 is attached to the first side wall 64. The cable support 72 includes a cable guide hole 73. An inner wire B42 of the control cable B4 extends through the cable guide hole 73. The cable support 72 includes a first rod support hole 74. The second side wall 66 includes a second rod support hole 76. The guide rod 54 is fitted in the first rod support hole 74 and the second rod support hole 76.

As seen in FIG. 7, the first support link 40 includes a pair of first link arms 78 and a first coupling part 80. The first link aims 78 extend from the first coupling part 80 to define a substantially squared U-shape. Each of the first link aims 78 includes a first proximal end 82 and a first distal end 84 opposite to the first proximal end 82. The first link aim 78 has an elongated shape extending between the first proximal end 82 and the first distal end 84. The first coupling part 80 couples the first distal ends 84. The first distal end 84 is pivotally coupled to the piston link 38 about the first support axis A12.

Each of the first link arms 78 includes a first link hole LH1 provided at the first distal end 84. The piston link 38 includes a pair of first support holes SH1. The first support holes SH1 are respectively provided on the third side wall 68 and the fourth side wall 70. The link structure 18 includes a pair of first support pins SP1. The first support pins SP1 define the first support axis A12. The first support pin SP1 extends through the first support hole SH1 and the first link hole LH1. The first support pin SP1 is fastened to one of the first support hole SH1 and the first link hole LH1.

As seen in FIG. 7, the second support link 52 includes a pair of second link arms 86 and a second coupling part 88. The second link arms 86 extend from the second coupling part 88 to define a substantially squared U-shape. Each of the second link arms 86 includes a second proximal end 90 and a second distal end 92 opposite to the second proximal end 90. The second link arm 86 has an elongated shape extending between the second proximal end 90 and the second distal end 92. The second coupling part 88 couples the second distal ends 92. The second proximal end 90 is pivotally coupled to the piston link 38 about the second support axis A22.

Each of the second link arms 86 includes a second link hole LH2 provided at the second proximal end 90. The piston link 38 includes a pair of second support holes SH2. The second support holes SH2 are respectively provided on the third side wall 68 and the fourth side wall 70. The link structure 18 includes a pair of second support pins SP2. The second support pins SP2 define the second support axis A22. The second support pin SP2 extends through the second support hole SH2 and the second link hole LH2. The second support pin SP2 is fastened to one of the second support hole SH2 and the second link hole L112.

As seen in FIG. 7, each of the first link arms 78 includes a first pivot hole PH1 provided between the first proximal end 82 and the first distal arm end 84. Each of the second link arms 86 includes a second pivot hole PH2 provided at the second distal end 92.

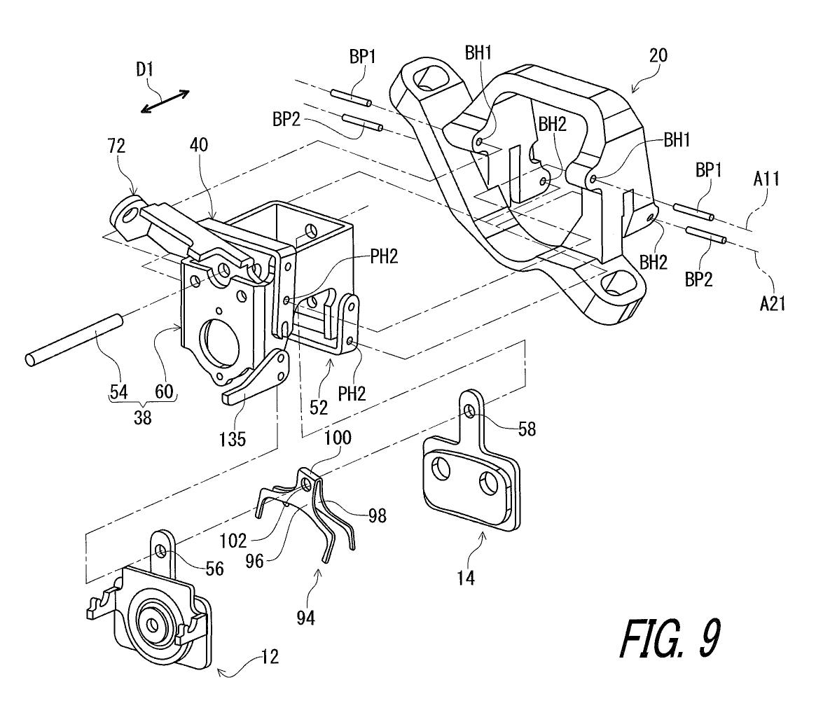

As seen in FIGS. 8 and 9, the caliper base 20 includes a pair of first base holes BH1 and a pair of second base holes BH2. The link structure 18 includes a pair of first base pins BP1 and a pair of second base pins BP2. The first base pins BP1 define the first base axis A11. The second base pins BP2 define the second base axis A21. The first base pin BP1 extends through the first pivot hole PH1 and the first base hole BH1. The second base pin BP2 extends through the second pivot hole PH2 and the second base hole BH2. The first base pin BP1 is fastened to one of the first pivot hole PH1 and the first base hole BH1. The second base pin BP2 is fastened to one of the second pivot hole PH2 and the second base hole BH2.

As seen in FIGS. 8 and 9, the bicycle disc brake caliper 10 comprises a biasing member 94 to respectively bias the first brake pad 12 and the second brake pad 14 toward the first operated position P12 and the second operated position P22. The biasing member 94 biases the first brake pad 12 and the second brake pad 14 to move away from each other. The biasing member 94 is mounted to the guide rod 54 and is provided between the first brake pad 12 and the second brake pad 14.

In this embodiment, the biasing member 94 includes a first biasing part 96, a second biasing part 98, and a connecting part 100. The connecting part 100 is provided between the first biasing part 96 and the second biasing part 98 to connect the first biasing part 96 and the second biasing part 98. The first biasing part 96 is in contact with the first brake pad 12. The second biasing part 98 is in contact with the second brake pad 14. The first biasing part 96 includes a first biasing hole 102 (FIG. 8). The second biasing part 98 includes a second biasing hole 104 (FIG. 9).

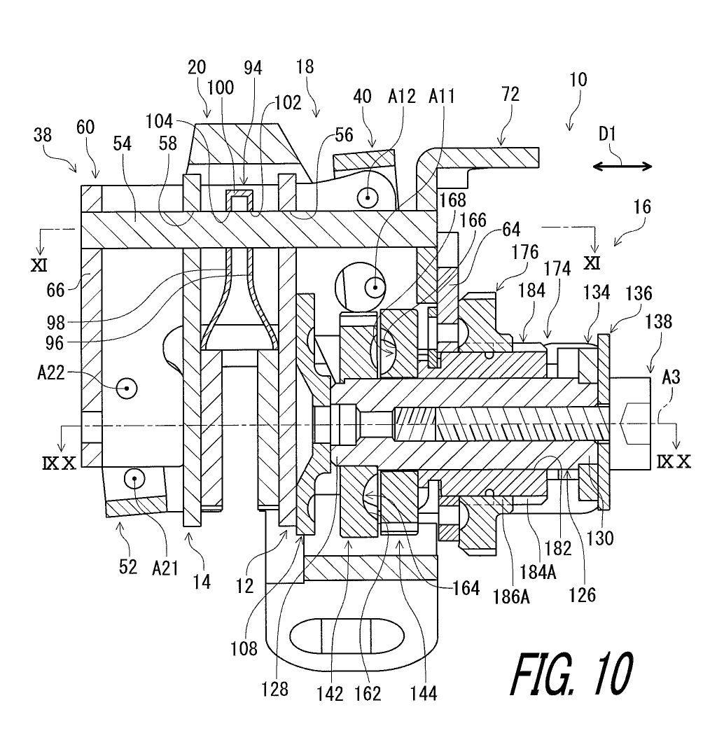

As seen in FIG. 10, the guide rod 54 extends through the first biasing hole 102 and the second biasing hole 104. The biasing member 94 can be other members such as an elastic member and a coiled spring.

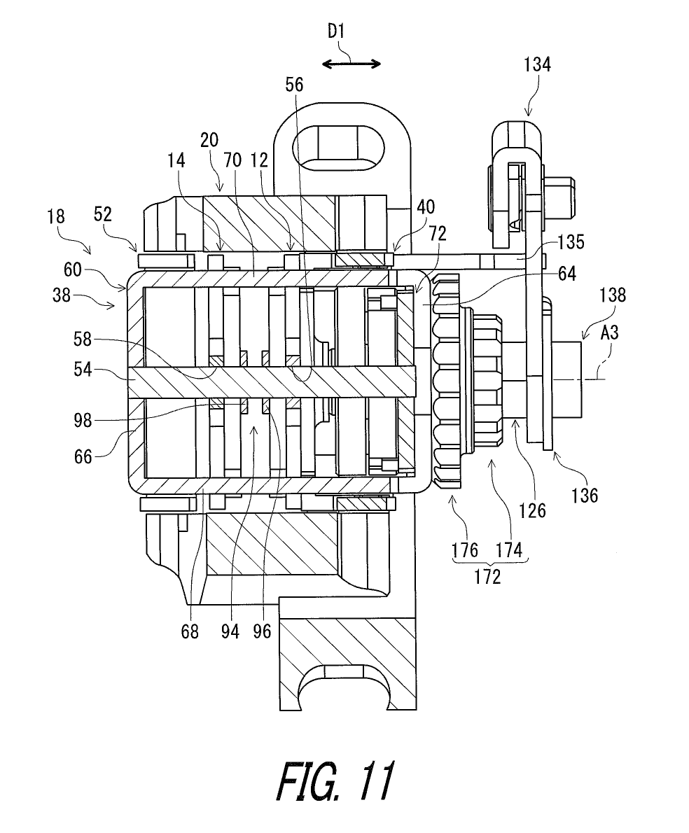

As seen in FIGS. 10 and 11, each of the first brake pad 12 and the second brake pad 14 is provided between the first side wall 64 and the second side wall 66 in the axial direction D1. The first brake pad 12 is provided between the first side wall 64 and the second brake pad 14 in the axial direction D1. The second brake pad 14 is provided between the second side wall 66 and the first brake pad 12 in the axial direction D1. As seen in FIG. 11, each of the first brake pad 12 and the second brake pad 14 is provided between the third side wall 68 and the fourth side wall 70.

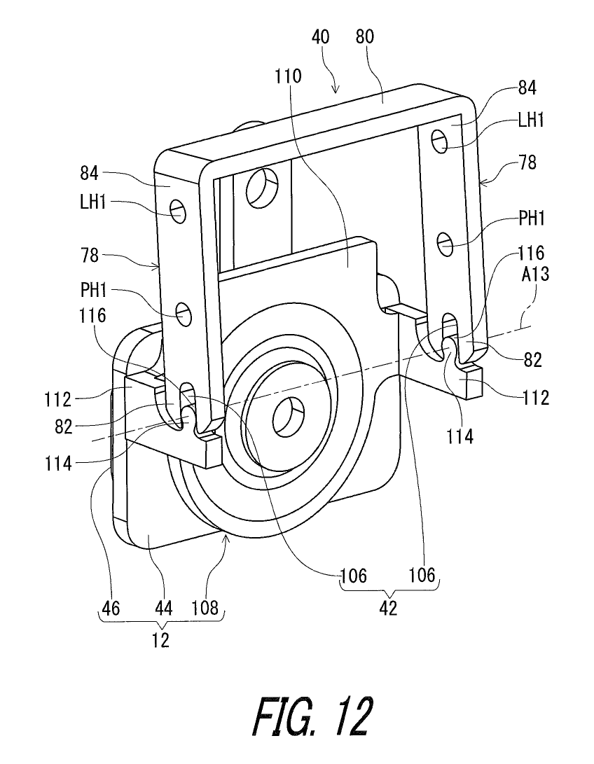

As seen in FIG. 12, the pad coupling portion 42 includes a pair of coupling slits 106 respectively provided at the first proximal ends 82 of the first link arms 78. The first brake pad 12 includes a receiving member 108. The receiving member 108 is attached to the first back plate 44 and is provided on an opposite side of the first friction member 46 with respect to the first back plate 44. The receiving member 108 includes a receiving body 110 and a pair of receiving arms 112. The receiving arms 112 extend from the receiving body 110. The receiving arms 112 are spaced apart from each other.

The receiving arms 112 are respectively coupled to the coupling slits 106. In this embodiment, each of the receiving arms 112 includes a protrusion 114. The protrusion 114 is movably provided in the coupling slit 106.

As seen in FIGS. 4 and 5, the protrusion 114 defines the coupling axis A13. The protrusion 114 includes a curved surface 116 provided about the coupling axis A13. The curved surface 116 is contactable with the first proximal end 82.

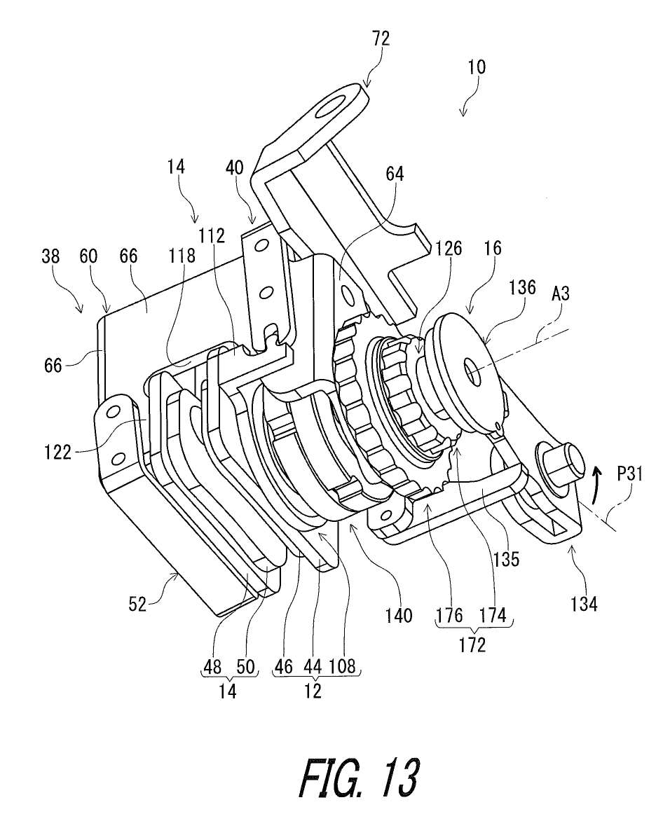

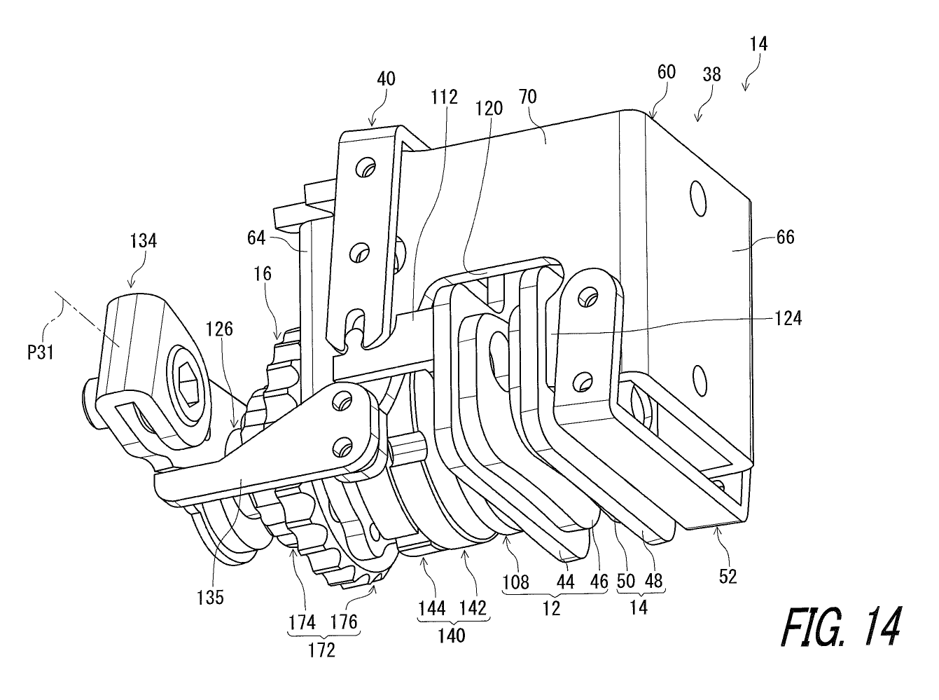

As seen in FIGS. 13 and 14, the receiving arms 112 are provided outside the cylindrical part 60 of the piston link 38. Specifically, the third side wall 68 includes a first recess 118 (FIG. 13). The fourth side wall 70 includes a second recess 120 (FIG. 14). Each of the first brake pad 12 and the second brake pad 14 is partially provided in the first recess 118 and the second recess 120. The receiving member 108 is partially provided in the first recess 118 and the second recess 120. The first support link 40 and the second support link 52 are provided outside of the cylindrical part 60 of the piston link 38.

The third side wall 68 includes a first contact part 122 (FIG. 13). The fourth side wall 70 includes a second contact part 124 (FIG. 14). Each of the first contact part 122 and the second contact part 124 is in contact with the second brake pad 14 to transmit the movement of the first brake pad 12 to the second brake pad 14 via the piston link 38. Specifically, each of the first contact part 122 and the second contact part 124 is in contact with the second back plate 48 of the second brake pad 14 to transmit the movement of the first brake pad 12 to the second brake pad 14 via the piston link 38.

The actuation structure 16 is provided on the piston link 38. The actuation structure 16 is attached to one of the plurality of side walls 64, 66, 68, and 70. In this embodiment, the actuation structure 16 is attached to the first side wall 64. However, the actuation structure 16 can be attached to another of the side walls 64, 66, 68, and 70. Furtheiniore, the actuation structure 16 can be attached to another part such as the caliper base 20 or the bicycle body B2.

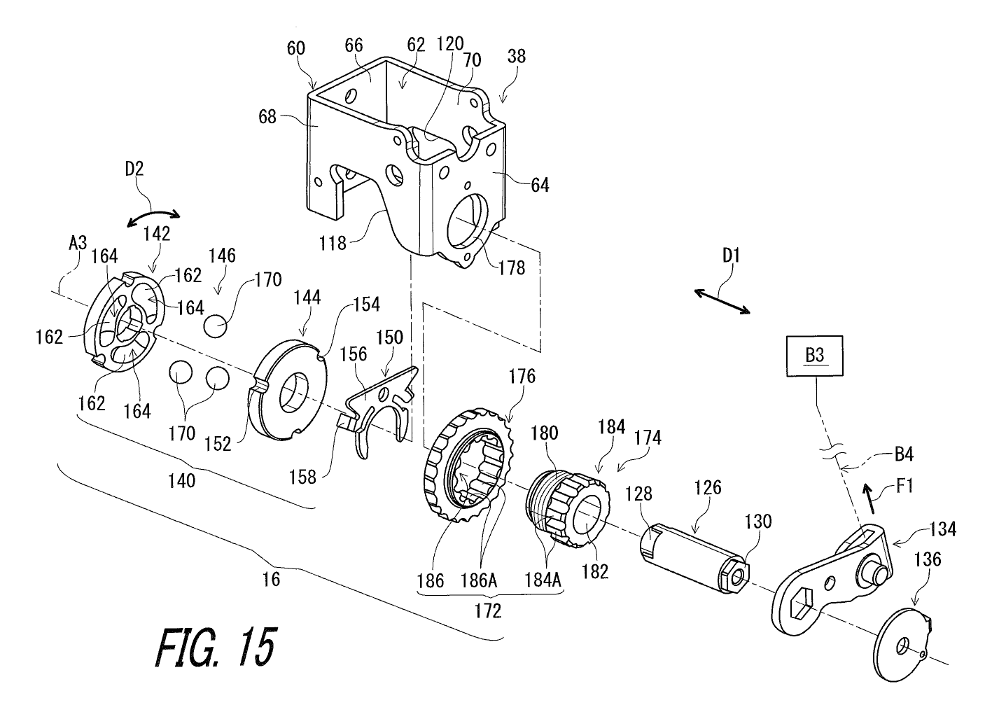

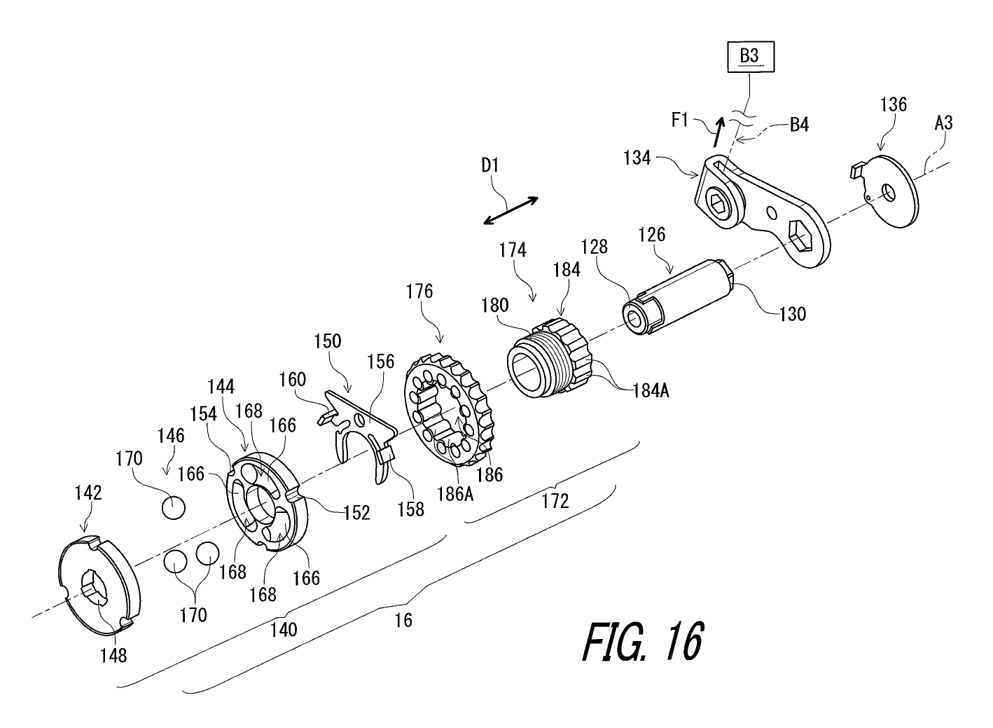

As seen in FIGS. 15 and 16, the actuation structure 16 includes a rotational member 126 coupled to the piston link 38 to rotate relative to the piston link 38 in response to the operation force F1 applied via the control cable B4. In this embodiment, the rotational member 126 is rotatably mounted to the piston link 38 about a rotational axis A3. The rotational member 126 is movably mounted to the piston link 38 in the axial direction D1. In this embodiment, the rotational axis A3 is defined along the axial direction D1. Specifically, the rotational axis A3 is parallel to the axial direction D1. However, the rotational axis A3 can be substantially parallel to the axial direction D1. Furthermore, the rotational axis A3 of the rotational member 126 can be non-parallel to the axial direction D1.

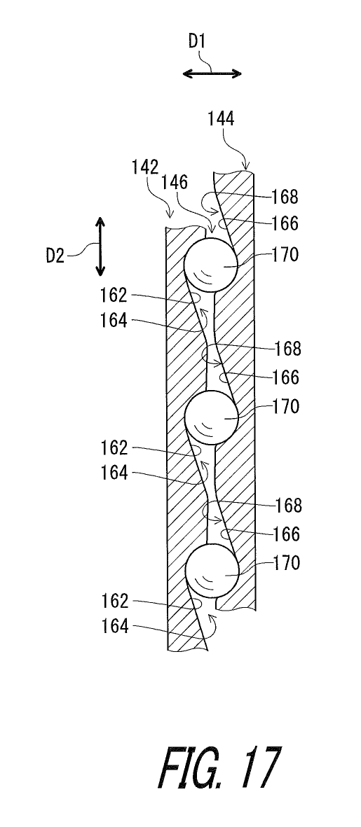

As seen in FIG. 17, the rotational member 126 is provided to contact the first brake pad 12 to transmit an actuation force of the actuation structure 16. The rotational member 126 is in contact with the receiving member 108 of the first brake pad 12. The rotational member 126 extends in the axial direction D1 and includes a first axial end 128 and a second axial end 130. The second axial end 130 is opposite to the first axial end 128 in the axial direction D1. The first axial end 128 is in contact with the receiving body 110 of the receiving member 108. The receiving body 110 includes a receiving surface 132 provided on an opposite side of the first friction member 46 with respect to the first back plate 44. The first axial end 128 of the rotational member 126 is in slidable contact with the receiving surface 132.

The biasing member 94 biases the first brake pad 12 toward the rotational member 126. The receiving surface 132 of the receiving body 110 is pressed against the first axial end 128 of the rotational member 126 by the biasing member 94. The biasing member 94 biases the first brake pad 12 and the rotational member 126 relative to the piston link 38 in the axial direction D1.

As seen in FIGS. 15 and 16, the actuation structure 16 includes a cable attachment member 134 to receive an end of the control cable B4. The cable attachment member 134 is coupled to the rotational member 126 to rotate integrally with the rotational member 126 relative to the piston link 38 and the caliper base 20 about the rotational axis A3. Specifically, the cable attachment member 134 and a washer 136 is secured to the second axial end 130 of the rotational member 126 with a fastener 138 (FIG. 17) such as a bolt. An end of the inner wire B42 is coupled to the cable attachment member 134. The rotational member 126 rotates relative to the piston link 38 and the caliper base 20 about the rotational axis A3 in response to the operation force F1 applied via the control cable B4.

As seen in FIG. 13, the piston link 38 includes a stopper 135 to position the cable attachment member 134 at an initial position P31 relative to the piston link 38. The stopper 135 is attached to the cylindrical part 60. The cable attachment member 134 is positioned at the initial position P31 relative to the piston link 38 in a state where the cable attachment member 134 is in contact with the stopper 135.

The actuation structure 16 includes a cam mechanism 140 provided between the rotational member 126 and the piston link 38 to move the rotational member 126 along the rotational axis A3 of the rotational member 126 relative to the piston link 38. In the illustrated embodiment, the cam mechanism 140 is mounted on the piston link 38 to move the rotational member 126 along the rotational axis A3 of the rotational member 126 relative to the piston link 38.

As seen in FIGS. 15 and 16, the cam mechanism 140 includes a first cam member 142, a second cam member 144, and an intermediate member 146. The first cam member 142 is provided on the rotational member 126. The second cam member 144 is provided on the piston link 38 and faces the first cam member 142. The intermediate member 146 is arranged between the first cam member 142 and the second cam member 144.

In this embodiment, the first cam member 142 is secured to the first axial end 128 of the rotational member 126. The first cam member 142 is rotatably mounted to the piston link 38 about the rotational axis A3 via the rotational member 126. The first cam member 142 is movably mounted to the piston link 38 in the axial direction D1 via the rotational member 126. The first cam member 142 includes a first hole 148. The first axial end 128 of the rotational member 126 extends through the first hole 148 and is fastened to the first hole 148 via adhesive or another fastening element. While the first cam member 142 is a separate member from the rotational member 126 in this embodiment, the first cam member 142 can be integrally provided with the rotational member 126 as a one-piece unitary member.

The second cam member 144 is coupled to the piston link 38. Specifically, the second cam member 144 is coupled to the first side wall 64 of the piston link 38. The second cam member 144 is restricted from rotating relative to the piston link 38 about the rotational axis A3. The cam mechanism 140 includes a restriction member 150. The restriction member 150 is secured to the first side wall 64 of the piston link 38 to restrict the second cam member 144 from rotating relative to the piston link 38 about the rotational axis A3.

As seen in FIG. 16, the second cam member 144 includes a first restriction groove 152 and a second restriction groove 154. The restriction member 150 includes an attachment body 156, a first restriction protrusion 158, and a second restriction protrusion 160. The first restriction protrusion 158 and the second restriction protrusion 160 extend from the attachment body 156 toward the first cam member 142 and the second cam member 144. The first restriction protrusion 158 is provided in the first restriction groove 152. The second restriction protrusion 160 is provided in the second restriction groove 154. While the second cam member 144 and the restriction member 150 are separate members from the piston link 38 in this embodiment, at least one of the second cam member 144 and the restriction member 150 can be integrally provided with the piston link 38.

As seen in FIG. 15, the first cam member 142 includes a plurality of first cam surfaces 162. The first cam surfaces 162 extend in the circumferential direction D2 and are spaced apart from each other in the circumferential direction D2. The first cam surfaces 162 extend in the circumferential direction D2. The first cam surface 162 defines a first cam groove 164.

As seen in FIG. 16, the second cam member 144 includes a plurality of second cam surfaces 166. The second cam surfaces 166 extend in the circumferential direction D2 and are spaced apart from each other in the circumferential direction D2. The second cam surfaces 166 extend in the circumferential direction D2. The second cam surface 166 defines a second cam groove 168. As seen in FIG. 17, the second cam surfaces 166 respectively face the first cam surfaces 162 in the axial direction D1.

As seen in FIGS. 15 and 16, the intermediate member 146 includes rolling elements 170. In this embodiment, the rolling elements 170 are balls. As seen in FIG. 17, the rolling elements 170 are respectively provided in the first cam grooves 164 and are respectively in contact with the first cam surfaces 162. The rolling elements 170 are respectively provided in the second cam grooves 168 to contact the second cam surfaces 166 and are respectively in contact with the second cam surfaces 166. The rolling element 170 is held in the first cam groove 164 and the second cam groove 168.

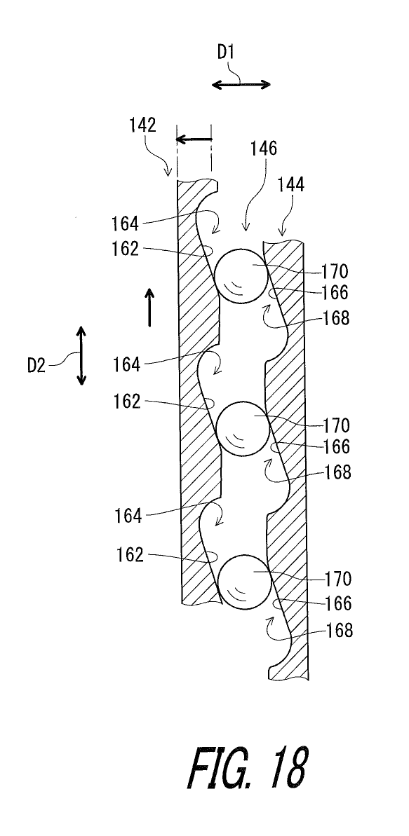

As seen in FIGS. 17 and 18, the first cam surfaces 162, the second cam surfaces 166, and the rolling elements 170 convert a relative rotation occurring between the first cam member 142 and the second cam member 144 into an axial relative movement occurring between the first cam member 142 and the second cam member 144. When the rotational member 126 rotates relative to the piston link 38 about the rotational axis A3 in response to the operation force F1 (FIG. 15) applied via the control cable B4, the cam mechanism 140 moves the rotational member 126 relative to the piston link 38 along the rotational axis A3. Thus, the first brake pad 12 is pressed toward the first operated position P12.

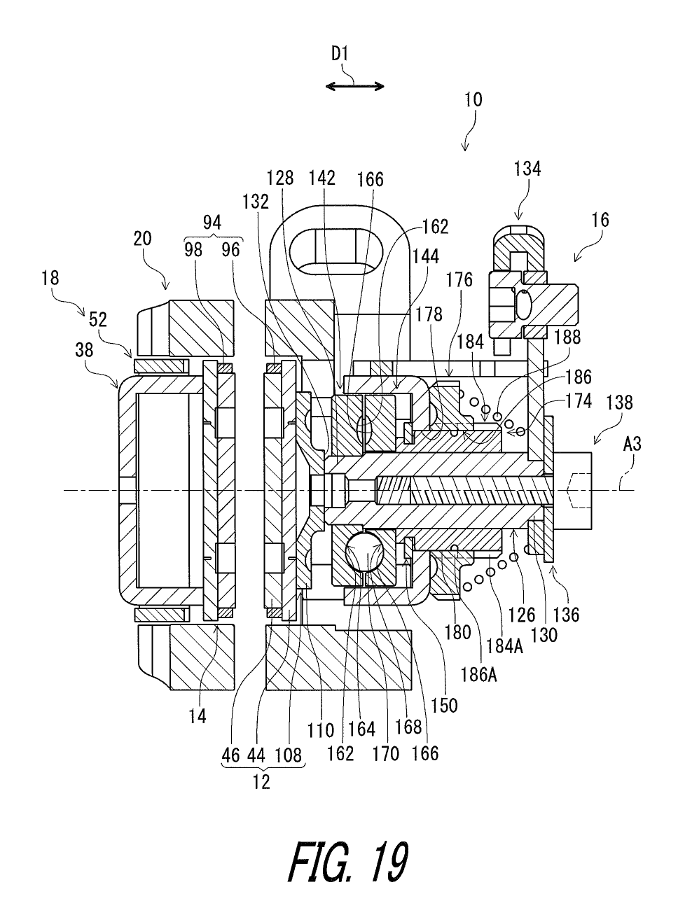

As seen in FIG. 19, the bicycle disc brake caliper 10 further comprises an adjustment structure 172. The adjustment structure 172 changes a position of the actuation structure 16 relative to the piston link 38 to adjust the rest position P11 of the first brake pad 12 relative to the caliper base 20. The adjustment structure 172 changes axial positions of the first cam member 142 and the second cam member 144 relative to the piston link 38 along the rotational axis A3 to adjust the rest position P11 of the first brake pad 12 relative to the caliper base 20.

The adjustment structure 172 changes the axial positions of the first cam member 142 and the second cam member 144 relative to the piston link 38 along the rotational axis A3 to adjust the first rest position P11 of the first brake pad 12 relative to the caliper base 20. Specifically, the adjustment structure 172 changes the axial position P3 of the second cam member 144 relative to the piston link 38 in the axial direction D1. The first cam member 142 and the first brake pad 12 are moved together with the second cam member 144 in the axial direction D1 by the adjustment structure 172. The first brake pad 12 and the second brake pad 14 are coupled by the link structure 18. Thus, the adjustment structure 172 changes the axial positions of the first cam member 142 and the second cam member 144 relative to the piston link 38 along the rotational axis A3 to adjust the second rest position P21 of the second brake pad 14 relative to the caliper base 20.

As seen in FIGS. 15 and 16, the adjustment structure 172 includes a first adjustment member 174 and a second adjustment member 176. The first adjustment member 174 is mounted to the piston link 38. The second adjustment member 176 is mounted to the piston link 38 via the first adjustment member 174. The first side wall 64 of the piston link 38 includes a threaded hole 178. The first adjustment member 174 extends through the threaded hole 178. The first adjustment member 174 includes an externally threaded part 180 engaged with the threaded hole 178. The first adjustment member 174 is rotatably mounted to the piston link 38 about the rotational axis A3. Rotation of the first adjustment member 174 moves an axial position of the first adjustment member 174 relative to the piston link 38 along the rotational axis A3.

In this embodiment, the first adjustment member 174 includes a first through hole 182. The rotational member 126 extends through the first through hole 182. The rotational member 126 is rotatably mounted to the first adjustment member 174 about the rotational axis A3 and is movably mounted to the first adjustment member 174 along the rotational axis A3.

The first adjustment member 174 includes an engagement part 184. The engagement part 184 includes a plurality of first teeth 184A arranged in a circumferential direction D2 defined about the rotational axis A3. The second adjustment member 176 has an annular shape. The second adjustment member 176 includes an engagement hole 186. The first adjustment member 174 extends through the engagement hole 186. The second adjustment member 176 includes a plurality of second teeth 186A arranged in the circumferential direction D2. The second teeth 186A define the engagement hole 186. The second teeth 186A mesh with the first teeth 184A. The first adjustment member 174 rotates integrally with the second adjustment member 176 relative to the piston link 38 about the rotational axis A3 when the second adjustment member 176 is rotated relative to the piston link 38 by the user. At this time, the first adjustment member 174 is movable relative to the second adjustment member 176 along the rotational axis A3.

While the engagement part 184 is integrally provided with the externally threaded part 180 as a one-piece unitary member in this embodiment, the engagement part 184 can be a separate member from the externally threaded part 180.

As seen in FIG. 19, the adjustment structure 172 includes an adjustment biasing member 188 to bias the second adjustment member 176 toward the piston link 38. The adjustment biasing member 188 is provided between the second adjustment member 176 and the cable attachment member 134 in a compressed manner. This makes an axial position of the second adjustment member 176 stable relative to the piston link 38. While the adjustment biasing member 188 is a coiled spring in this embodiment, the adjustment biasing member 188 can be other biasing members.

The bicycle disc brake caliper 10 includes the following features.

(1) The bicycle disc brake caliper 10 comprises a first brake pad 12, a second brake pad 14, an actuation structure 16, and a link structure 18. The second brake pad 14 is arranged to face the first brake pad 12. The actuation structure 16 moves the first brake pad 12 toward the second brake pad 14. The link structure 18 is coupled to the first brake pad 12 to transmit a movement of the first brake pad 12 to the second brake pad 14 to move the second brake pad 14 toward the first brake pad 12. Accordingly, it is possible to utilize the movement of the first brake pad 12 to move the second brake pad 14 using the link structure 18, allowing the structure of the bicycle disc brake caliper 10 to be simplified.

(2) The bicycle disc brake caliper 10 further comprises a caliper base 20 coupled to a bicycle body B2. The link structure 18 is provided on the caliper base 20. Accordingly, it is possible to support the link structure 18 via the caliper base 20 relative to the bicycle body B2, allowing operation of the link structure 18 to be stabilized.

(3) The link structure 18 includes a piston link 38 to move the second brake pad 14 toward the first brake pad 12, and a first support link 40 pivotally coupled to the caliper base 20 about a first base axis A11 and pivotally coupled to the piston link 38 about a first support axis A12. Accordingly, it is possible to move the second brake pad 14 toward the first brake pad 12 using the piston link 38 and the first support link 40.

(4) The first support link 40 is coupled to the first brake pad 12 to transmit the movement of the first brake pad 12 to the piston link 38. Accordingly, it is possible to transmit the movement of the first brake pad 12 to the second brake pad 14 via the first support link 40 and the piston link 38.

(5) The first support link 40 includes a pad coupling portion 42 coupled to the first brake pad 12. The pad coupling portion 42 is arranged farther from the first support axis A12 than the first base axis A11. Accordingly, it is possible to move the piston link 38 via the first support link 40 in an opposite direction opposite to a direction in which the first brake pad 12 moves. This allows the second brake pad 14 to move in the opposite direction in conjunction with the movement of the first brake pad 12.

(6) The first brake pad 12 includes a first back plate 44 and a first friction member 46 attached to the first back plate 44. The pad coupling portion 42 of the first support link 40 is pivotally coupled to the first back plate 44 about a coupling axis A13. Accordingly, it is possible to couple the first support link 40 to the first back plate 44 of the first brake pad 12 via the pad coupling portion 42. This can improve transmission efficiency of the movement of the first brake pad 12 relative to the second brake pad 14.

(7) The actuation structure 16 is provided on the piston link 38. Accordingly, a reaction force is applied from the actuation structure 16 to the piston link 38 when an actuation force is applied from the actuation structure 16 to the first brake pad 12. Thus, it is possible to utilize the reaction force as an actuation force for the second brake pad 14.

(8) At least one of the first brake pad 12 and the second brake pad 14 is mounted to the piston link 38. Accordingly, it is possible to simplify the structure of the bicycle disc brake caliper 10.

(9) The piston link 38 has a guide rod 54. At least one of the first brake pad 12 and the second brake pad 14 is movably mounted to the piston link 38 along the guide rod 54. Accordingly, it is possible to guide the at least one of the first brake pad 12 and the second brake pad 14 relative to the piston link 38, allowing a movement of the at least one of the first brake pad 12 and the second brake pad 14 to be stabilized.

(10) The piston link 38 has a cylindrical part 60 defining an internal space 62. The first brake pad 12 and the second brake pad 14 are at least partially arranged in the internal space 62 of the cylindrical part 60. Accordingly, it is possible to protect at least part of the first brake pad 12 and the second brake pad 14 using the piston link 38.

(11) The cylindrical part 60 includes a plurality of side walls defining a rectangular cylindrical shape. The actuation structure 16 is attached to one of the plurality of side walls. Accordingly, it is possible to increase strength of the piston link 38 because of the rectangular cylindrical shape, allowing the actuation structure 16 to be stably supported via the piston link 38.

(12) The link structure 18 further includes a second support link 52 pivotally coupled to the caliper base 20 about a second base axis A21 and pivotally coupled to the piston link 38 about a second support axis A22. Accordingly, it is possible to stably support the piston link 38 relative to the caliper base 20 along with the first support link 40.

(13) The first and second support axes A12 and A22 and the first and second base axes A11 and A21 are arranged so as to constitute a four-bar linkage between the piston link 38 and the caliper base 20. Accordingly, it is possible to stabilize a movement of the piston link 38 relative to the caliper base 20 using the four-bar linkage.

(14) The first and second support axes A12 and A22 and the first and second base axes A11 and A21 are arranged so as to be parallel to each other. Accordingly, it is possible to make the movement of the piston link 38 relative to the caliper base 20 more stable using the four-bar linkage.

(15) A first distance L1 defined between the first support axis A12 and the first base axis A11 is equal to a second distance L2 defined between the second support axis A22 and the second base axis A21. A third distance L3 defined between the first support axis A12 and the second support axis A22 is equal to a fourth distance L4 defined between the first base axis A11 and the second base axis A21. The first distance L1 and the second distance L2 are shorter than the third distance L3 and the fourth distance L4. Accordingly, it is possible to make the movement of the piston link 38 relative to the caliper base 20 more stable using the four-bar linkage.

(16) The actuation structure 16 includes a rotational member 126 coupled to the piston link 38 to rotate relative to the piston link 38 in response to an operation force F1 applied via a control cable B4. Accordingly, it is possible to receive the operation force F1 from the control cable B4 via the rotational member 126.

(17) The actuation structure 16 includes a cam mechanism 140 provided between the rotational member 126 and the piston link 38 to move the rotational member 126 along a rotational axis A3 of the rotational member 126 relative to the piston link 38. Accordingly, it is possible to convert the operation force F1 to an axial movement of the rotational member 126 via the cam mechanism 140.

(18) The cam mechanism 140 includes a first cam member 142, a second cam member 144, and an intermediate member 146. The first cam member 142 is provided on the rotational member 126. The second cam member 144 is provided on the piston link 38 and faces the first cam member 142. The intermediate member 146 is arranged between the first cam member 142 and the second cam member 144. Accordingly, it is possible to convert rotation of the rotational member 126 into the axial movement of the rotational member 126 via the first cam member 142, the second cam member 144, and the intermediate member 146.

(19) The bicycle disc brake caliper 10 further comprises an adjustment structure 172 changing axial positions of the first cam member 142 and the second cam member 144 relative to the piston link 38 along the rotational axis A3 to adjust a rest position of the first brake pad 12 relative to the caliper base 20. Accordingly, it is possible to adjust a position of the first brake pad 12 relative to the piston link 38 via the adjustment member.

(20) The bicycle disc brake caliper 10 further comprises an adjustment structure 172 changing a position of the actuation structure 16 relative to the piston link 38 to adjust a rest position of the first brake pad 12 relative to the caliper base 20. Accordingly, it is possible to adjust a position of the first brake pad 12 relative to the piston link 38 via the adjustment member.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have”, “include” and their derivatives.

The terms “member”, “section”, “portion”, “part” and “element” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element”, and the term “second element” itself does not imply an existence of “first element.”

The term “pair of”, as used herein, can encompass the configuration in which the pair of elements have different shapes or structures from each other in addition to the configuration in which the pair of elements have the same shapes or structures as each other.

Finally, terms of degree such as “substantially”, “about” and “approximately” as used herein mean a reasonable amount of deviation of the modified term such that the end result is not significantly changed.

Obviously, numerous modifications and variations of the present invention are possible in light of the above teachings. It is therefore to be understood that within the scope of the appended claims, the invention may be practiced otherwise than as specifically described herein.

What is claimed is:

1. A bicycle disc brake caliper comprising:
a first brake pad;
a second brake pad arranged to face the first brake pad;
an actuation structure moving the first brake pad toward the second brake pad; and
a link structure coupled to the first brake pad to transmit a movement of the first brake pad to the second brake pad to move the second brake pad toward the first brake pad.

2. The bicycle disc brake caliper according to claim 1, further comprising:
a caliper base coupled to a bicycle body, wherein
the link structure is provided on the caliper base.

3. The bicycle disc brake caliper according to claim 2, wherein
the link structure includes
a piston link to move the second brake pad toward the first brake pad, and
a first support link pivotally coupled to the caliper base about a first base axis and pivotally coupled to the piston link about a first support axis.

4. The bicycle disc brake caliper according to claim 3, wherein
the first support link is coupled to the first brake pad to transmit the movement of the first brake pad to the piston link.

5. The bicycle disc brake caliper according to claim 4, wherein
the first support link includes a pad coupling portion coupled to the first brake pad, and
the pad coupling portion is arranged farther from the first support axis than the first base axis.

6. The bicycle disc brake caliper according to claim 5, wherein
the first brake pad includes a first back plate and a first friction member attached to the first back plate, and
the pad coupling portion of the first support link is pivotally coupled to the first back plate about a coupling axis.

7. The bicycle disc brake caliper according to claim 3, wherein
the actuation structure is provided on the piston link.

8. The bicycle disc brake caliper according to claim 3, wherein
at least one of the first brake pad and the second brake pad is mounted to the piston link.

9. The bicycle disc brake caliper according to claim 8, wherein
the piston link has a guide rod, and
at least one of the first brake pad and the second brake pad is movably mounted to the piston link along the guide rod.

10. The bicycle disc brake caliper according to claim 3, wherein
the piston link has a cylindrical part defining an internal space, and
the first brake pad and the second brake pad are at least partially arranged in the internal space of the cylindrical part.

11. The bicycle disc brake caliper according to claim 10, wherein
the cylindrical part includes a plurality of side walls defining a rectangular cylindrical shape, and
the actuation structure is attached to one of the plurality of side walls.

12. The bicycle disc brake caliper according to claim 3, wherein
the link structure further includes a second support link pivotally coupled to the caliper base about a second base axis and pivotally coupled to the piston link about a second support axis.

13. The bicycle disc brake caliper according to claim 12, wherein
the first and second support axes and the first and second base axes are arranged so as to constitute a four-bar linkage between the piston link and the caliper base.

14. The bicycle disc brake caliper according to claim 13, wherein
the first and second support axes and the first and second base axes are arranged so as to be parallel to each other.

15. The bicycle disc brake caliper according to claim 13, wherein
a first distance defined between the first support axis and the first base axis is equal to a second distance defined between the second support axis and the second base axis,
a third distance defined between the first support axis and the second support axis is equal to a fourth distance defined between the first base axis and the second base axis, and
the first distance and the second distance are shorter than the third distance and the fourth distance.

16. The bicycle disc brake caliper according to claim 3, wherein
the actuation structure includes a rotational member coupled to the piston link to rotate relative to the piston link in response to an operation force applied via a control cable.

17. The bicycle disc brake caliper according to claim 16, wherein
the actuation structure includes a cam mechanism provided between the rotational member and the piston link to move the rotational member along a rotational axis of the rotational member relative to the piston link.

18. The bicycle disc brake caliper according to claim 17, wherein
the cam mechanism includes
a first cam member provided on the rotational member,
a second cam member provided on the piston link and facing the first cam member, and
an intermediate member arranged between the first cam member and the second cam member.

19. The bicycle disc brake caliper according to claim 18, further comprising:
an adjustment structure changing axial positions of the first cam member and the second cam member relative to the piston link along the rotational axis to adjust a rest position of the first brake pad relative to the caliper base.

20. The bicycle disc brake caliper according to claim 3, further comprising:
an adjustment structure changing a position of the actuation structure relative to the piston link to adjust a rest position of the first brake pad relative to the caliper base.
